(19) United States
(12) Patent Application Publication
(10) Pub. No.: US 2007/0094279 A1
(43) Pub. Date: Apr. 26, 2007

(54) Service provision in peer-to-peer networking environment

(75) Inventors: Gaurav Mittal, Tampere (FI); Martin Bergenwall, Julkujarvi (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/256,435

(22) Filed: Oct. 21, 2005

(51) Int. Cl. G06F 7/00

(52) U.S. Cl. 707/100

(57) ABSTRACT

The present invention related to peer-to-peer communications systems. The system comprises a user profile association storage associating at least two user instance identifiers with prioritization information. In one aspect of the invention a user instance identifier associated with a peer-to-peer data transfer action is detected. The prioritization information for the data transfer action is checked from the user profile association information storage, and the data transfer action is adapted in accordance with the prioritization information.

### FIELD OF THE INVENTION

The present invention relates to a method and equipment for arranging service provision in a multi-network environment, in particular in an environment facilitating peer-to-peer (P2P) networking.

### BACKGROUND OF THE INVENTION

Peer-to-peer (P2P) networking relies on the computing power and bandwidth of the participating devices instead of having a centralized network system. P2P networks are thus ad-hoc networks dynamically established on top of existing networks. P2P networking is widely used for file sharing in fixed networks, especially between users having a data transfer connection of a good capacity and typically applying some digital subscriber line (DSL) technology.

Some distribution technologies employ rating systems, the basic principle of which is that a node allowing files to be uploaded gets a better rating for downloading. For instance, the eMule system follows how much uploading and downloading has been done from an individual user node and adapts the node's rating accordingly. A user identifier (ID) is applied in eMule to identify the user's workstation. Another distribution technology applying rating is the BitTorrent. The description of the BitTorrent protocol v. 1.0 can be obtained at http://www.bittorrent.com. In BitTorrent peers have unique client identifiers (peer_id) generated by the client at startup. In the compact version of BitTorrent no peer identifiers are used, but IPv4 (Internet Protocol version 4) addresses are applied.

However, a user may have multiple devices capable of peer-to-peer networking. A user may have a desktop computer with high bandwidth access to the Internet and a wireless device with a P2P peer software of more limited data transmission capabilities. Thus the user may not be willing to upload information from his or her wireless device due to limited bandwidth and costs of using the radio interface resources. The user would not have a good rating for downloading to the wireless terminal.

### BRIEF DESCRIPTION OF THE INVENTION

An object of the invention is to enhance service provision in peer-to-peer communications system. The object of the invention is achieved by a method, communications devices, a communications system and computer program products which are characterized by what is disclosed in the independent claims. Some embodiments of the invention are set forth in the dependent claims.

The invention is based on arranging in the system a user profile association storage associating at least two user instance identifiers with prioritization information. In one aspect of the invention a user instance identifier associated with a peer-to-peer data transferring action is detected. The prioritization information for the data transferring action is checked from the user profile association information storage, and the data transferring action is adapted in accordance with the prioritization information.

The term prioritization information refers generally to information on the basis of which properties of data transfer to a communications device may be adapted. Hence, the prioritization information may define or be used to adjust one or more quality of service settings, and it is not limited to defining the priorities of different users. The user instance identifier is to be understood broadly as an identifier associated with P2P communications, hence identifying an instance or entity participating in P2P communications. The user instance identifier may directly or indirectly identify the user, a device, or a P2P application, for instance. As an example, a user may use two different devices, whereby the identifiers of these devices are separate user instance identifiers. In view of the P2P system, the storage may associate P2P applications with the prioritization information, since identifiers of, submitted by, or used by the P2P applications may be defined in the storage. The user instance identifier may be indicated in a P2P message or retrieved from another position, such as from a network layer protocol header portion or from another device. The checking of the prioritization information may refer to an action performed in a single device or involving multiple devices: in one embodiment a request for prioritization information is transferred to a proxy device comprising or connected to the storage. Further, the detection of the user instance identifier may be carried out on the basis of a need for a data transfer action in a P2P device or on the basis of a message comprising the user instance identifier and received in a first P2P device from a second P2P device.

In one embodiment of the invention the user profile association information storage is arranged for associating at least two user instance identifiers from at least two devices with single prioritization information item.

One advantage of the invention is that it is possible to apply common prioritization for different user instances. Separate virtual user profile identifiers, user device identifiers, or other identifiers linked to the user may be defined in a single user entry or account and P2P data transfer associated with any one of these user instances may affect the data transfer associated with the other user instances. As an example, a user may actively upload data from a first device and thus enhance his or her prioritization information and hence service ranking to allow downloading with high quality of service. The user may then utilize this “earned” credit or reputation in the P2P system when downloading to a second device. The user is thus able to select which device or a logical profile to use for different purposes and even prevent sharing of information from a particular user instance, such as from his or her mobile communications device.

### BRIEF DESCRIPTION OF THE DRAWINGS

In the following, the invention will be described in further detail by means of some embodiments and with reference to the accompanying drawings, in which

FIG. 1 is a block diagram illustrating a peer-to-peer networking environment;

FIGS. 2a and 2b are simplified block diagrams illustrating communications devices;

FIG. 3 is a table comprising user profile association information according to an embodiment of the invention;

FIGS. 4a and 4b are flow charts illustrating a method according to an embodiment of the invention; and

FIGS. 5a and 5b are flow charts illustrating a method according to an embodiment of the invention.

### DETAILED DESCRIPTION OF THE INVENTION

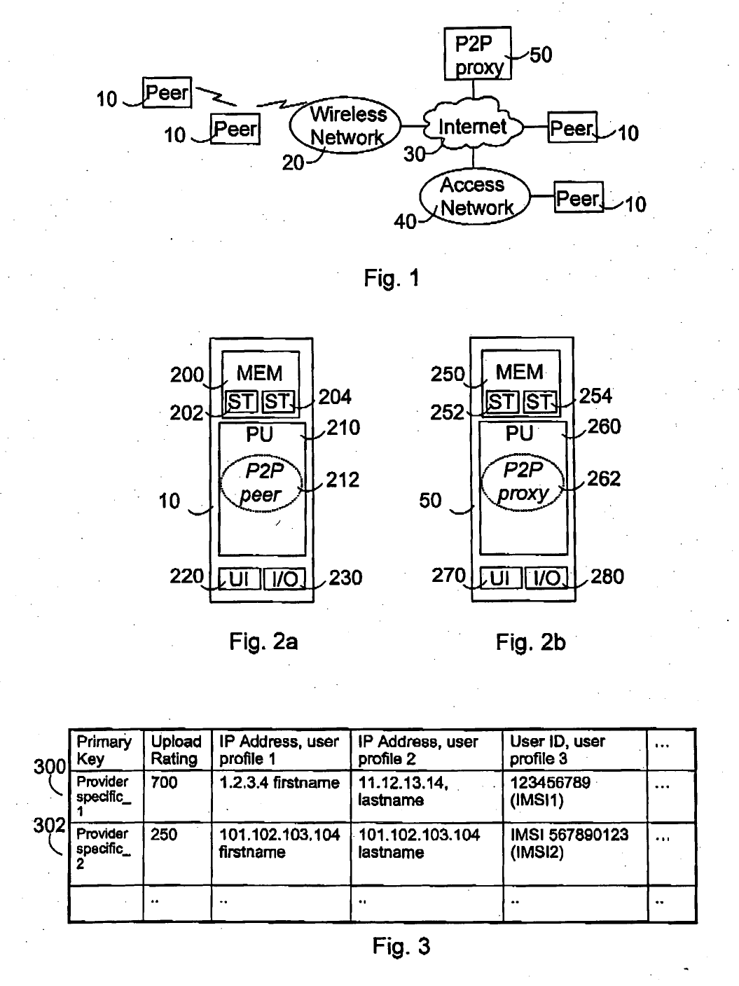

FIG. 1 illustrates a peer-to-peer networking environment comprising a plurality of devices comprising P2P communication capabilities, herein referred to as peer devices 10. In view of P2P communication and an overlay P2P network these devices are all P2P peers regardless of their underlying capabilities. As illustrated in FIG. 1, peer devices 10 may be wireless de vices connected to a wireless network 20, directly connected to the Internet 30, or connected to the Internet 30 via one or more access networks 40. The peer device 10 could be a network server, a PC (personal computer), a mobile communications device, a domestic appliance, a personal entertainment or data browsing device, a laptop computer or a PDA device, for instance.

The wireless network 20 and the peer device 10 communicating via the wireless network 20 may support some wireless network technology, such as GSM, GPRS (General Packet Radio Service), third-generation mobile communications, such as one according to the 3GPP (3^{rd} Generation Partnership Project) network specifications, fourth generation communications, wireless local area networking, or some private networking technology. It is to be noted that the peer devices 10 may be configured to communicate directly without any intermediate networks, for instance by using a wireless local connection, such as a WLAN or a Bluetooth connection. In addition to the examples of FIG. 1, other networking scenarios are naturally also possible.

According to an embodiment of the present invention, a P2P proxy is applied in P2P communication. In FIG. 1 the P2P proxy 50 is connected to the Internet 30. It is to be noted that the P2P proxy 50 could also be arranged in the access network 40, in the mobile network 20, or in one or more peer devices 10. The P2P proxy 50 may be a dedicated device or an additional service provided in a device with P2P communications capabilities. For instance, the P2P proxy 50 could be a network server, a mobile communications network element, or a PC. The P2P proxy functionality could even be implemented in one or more peer devices 10. One important function of the P2P proxy 50 is to maintain a user profile association storage comprising entries for different registered users. Each entry comprises the user instance identifiers associated with the respective user, in one embodiment the IP addresses of the different devices of the user, and prioritization information of the user for adapting P2P communication of the user. The user's prioritization information may be maintained in many ways depending on the applied P2P protocol and may also be referred to as quality of service (QoS) information. In the following, rating of the user for P2P communication is applied as the prioritization information. The better rating the user has, the better service he or she gets in the P2P environment. The user's prioritization information is maintained on the basis of upload and/or download activities carried out by any one of the user's devices 10 registered with the user profile association storage.

FIG. 2a illustrates a communications device configured to function as a peer device 10 and FIG. 2b illustrates a communications device configured to function as a P2P proxy device 50. The I/O means 230, 280 of the communications devices 10, 50 comprise a transceiver for arranging data transfer. The communications devices 10, 50 further comprise memory 200, 250, a user interface 220, 270 and a processing unit comprising one or more processors. Computer program codes stored in the memory 200, 250 executed in the processing unit 210, 260 may be used for causing the communications devices 10, 50 to implement means for providing inventive functions relating to applying the user profile association storage, some embodiments of the inventive functions being illustrated below in association with FIGS. 3, 4a, 4b, 5a, and 5b. A chip unit or some other kind of hardware module for controlling the communications device 10, 50 may, in one embodiment, cause the device 10, 50 to perform the inventive functions. Such hardware module comprises connecting means for connecting the communications device 10, 50 mechanically and/or functionally. Thus, the hardware module may form part of the device and it may be removable. Some examples of such hardware module are a sub-assembly, a portable data storage medium, an IC card, or an accessory device. Computer program codes can be received via a network and/or be stored in memory means, for instance on a disk, a CD-ROM disk or other external memory means, from where they can be loaded into the memory of the communications devices 10, 50. The computer program can also be loaded through a network by using a TCP/IP protocol stack, for instance. It is also feasible to apply hardware features to implement the inventive functions.

The communications device 10 may be arranged to function as the P2P peer by executing, as illustrated by reference 212, P2P peer software (that may be stored in a storage area 202) in the processing unit 210. The executed P2P peer software uses the resources of the transceiver for providing transfer of P2P data. The communications device 50 may be configured to function as the P2P proxy by executing 262 specific P2P proxy software in the processing unit 260. As illustrated in FIG. 2b, the memory 250 of the P2P proxy device 50 may comprise a storage area 252 for the P2P proxy software and a storage area 254 for the user profile association information. It is to be noted that a single communications device may function both as the P2P peer and the P2P proxy. There may also be more than one P2P peer application 212 or P2P peer application instance running in the peer device 10, whereby each P2P application or application instance is considered as a separate user instance in view of the user profile association information storage.

FIG. 3 illustrates an embodiment of the user profile association information arranged in table format. The table comprises accounts 300, 302 specific for a certain user or a user group and for associating at least two user instance identifiers with prioritization information items. It is to be noted that the prioritization information may be stored in an appropriate format for the applied P2P protocol, such that the P2P (peer) protocol entity is able to adapt properties of a P2P transmission process for an associated device to substantially correspond the level of service indicated by the prioritization information, or as below, the rating information. Each account 300, 302 comprises space for a primary key and for rating information. A unique primary key may be used for searching for an appropriate account when retrieving and updating (the rating) information in the table. Different primary key types may be applied in different networks. In one embodiment a unique user identifier is used as the primary key. The primary key may be used for identifying the account 300, 302. Each account 300, 302 also comprises a plurality of user instance identifiers, hereinafter referred to as identifiers, for the user. Each identifier in the account 300, 302 may represent a specific profile and/or a device of the user. The user may thus have multiple devices associated with the same rating and use them even simultaneously. The set of identifiers in the account 300, 302 represents user instances in the P2P network, and is associated to the rating information for determining similar treatment for these different user instances. As shown in FIG. 3, the user account 300, 302 may comprise different types of identifiers. In one embodiment the international mobile subscriber number (IMSI) is applied for identifying a subscriber identity module (SIM) in a mobile communications device.

It is to be noted that the table in FIG. 3 is only one example and the implementation of the user profile association information storage is not limited to any specific format. For instance, the table in FIG. 3 may be adapted such that there is no primary key, and identifiers in different profiles are directly used for searching for an appropriate account when retrieving and updating information in the table. At least some of the following identifiers may be applied in the user profile association information storage: a P2P application specific identifier (i.e. an identifier of a P2P application or an identifier specified by a P2P application), an IPv4 or IPv6 address, a domain name, a port number, a user identifier, an overlay network identifier, a mobile subscriber identifier such as the IMSI, an international mobile equipment identity (IMEI), or some other type of device identifier, for instance an electronic serial number (ESN). For instance, the user identifier or the application specific identifier representing the P2P peer could be a user specified identifier, an identifier calculated using a hash method with random numbers, an identifier calculated using any random number generation method with strings, or an identifier calculated using a concatenation of other identifiers, for instance an IP address and a port number. In one embodiment IMSI, IMEI, or ESN is used as the primary key. It is feasible to apply a combination of two or more of the above mentioned identifiers as a user instance identifier.

As already mentioned, the account 300, 302 in the user profile association information storage may be user group specific. Hence, the P2P communication of all user's directly or indirectly identified in the account may be affected by the common rating information. For instance, family members may share an account, and IP addresses for the family members' devices are listed in the account. In the following, some embodiments are described by referring to user specific embodiments but these embodiments may well be applied also to user group specific accounts.

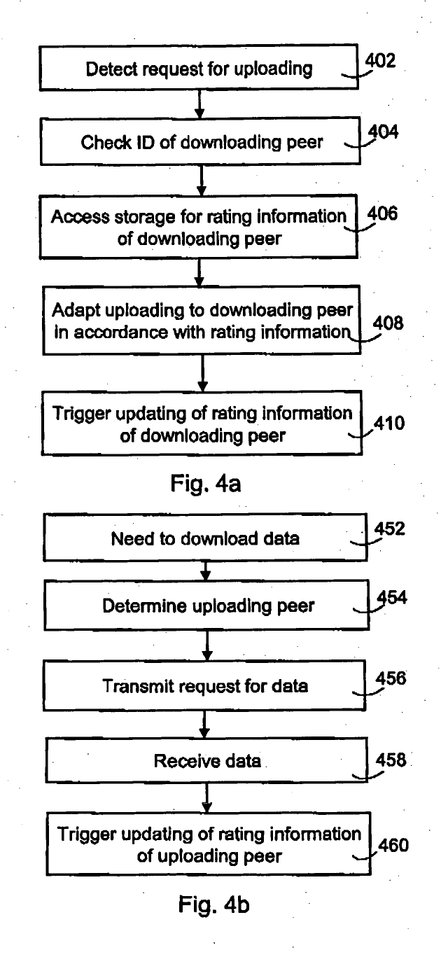

FIGS. 4a and 4b illustrate a file uploading and downloading process, respectively, in a peer device 10. The P2P peer software 212 may implement or control these features. In the following a peer device 10 uploading data, i.e. transmitting the data on the basis of a request from another peer, is referred to as the uploading peer, whereas the peer requesting and receiving the data is referred to as the downloading peer.

In step 402 a request for uploading data, such as a file or a part of a file, is detected. An identifier of the downloading peer, i.e. the peer device 10 that has transmitted the request for the data, is checked in step 404. Access to the user profile association storage (254) is arranged in step 406 in order to obtain rating information of the downloading peer. In the centralized approach utilizing the P2P proxy 50, the device implementing the method of FIG. 4a may transmit a rating information request comprising the identifier of a downloading peer. The P2P proxy 50 retrieves the rating information and transmits a response, which is then received in the uploading peer.

In step 408 the uploading of the file or the portion of the file is adapted in accordance with the received rating information of the downloading peer. This step may be carried out in accordance with the applied P2P protocol and needs not to be discussed in detail herein. It is to be noted that the file transmission process and/or one or more transmission parameters may be adapted on the basis of the rating information. For instance, data transmission order or rate may be defined on the basis of the rating information. The prioritization information or the rating information shared by multiple user instances may thus be used for defining the quality of service provided to the downloading peer.

In step 410 updating of rating information of the downloading peer is triggered. Thus, a message causing the updating of the rating information may be transmitted to the P2P proxy 50, the message identifying at least the downloading peer.

Referring now to FIG. 4b, the downloading process is described. In step 452 there is a need to download data, a file, a set of files, or a portion of a file in accordance with an applied P2P protocol. In step 454 an appropriate peer for uploading is determined 454 in accordance with the applied P2P protocol. It is to be noted that multiple peers may be used for requesting the uploading of the file in which case the steps in FIG. 4b are carried out for each uploading peer. In step 456 a request for the data is transmitted to the selected uploading peer. In step 458 the requested data is received. In step 460 updating of rating information of the uploading peer is triggered. Similarly to the step 410, a rating information update request may be transmitted to the P2P proxy 50, the request now indicating on upload procedure and comprising an identifier of the uploading peer.

The messages formed and transmitted in steps 410 and 460 may also comprise other information for updating the rating information, for instance the amount of data received from the uploading peer. Another example of such other information is the data transfer rate or other properties of the (downloading and/or the uploading) peer 10.

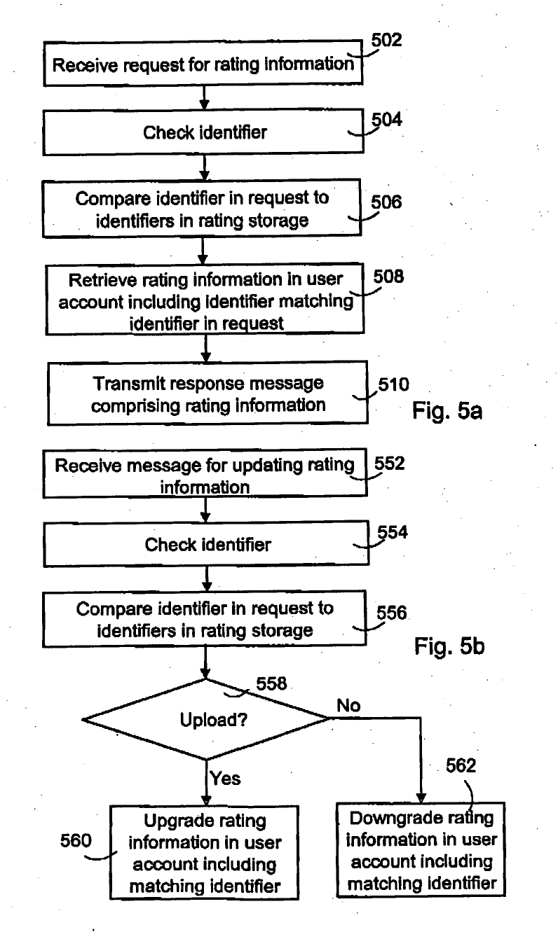

FIG. 5a illustrates information retrieval from the user profile association storage and FIG. 5b illustrates rating information updating. The steps in these figures may be provided by the P2P proxy software 262 in the device 50 functioning as the P2P proxy. In step 502 a request for rating information is received. An identifier included in the request (or another identifier defined on the basis of the request) is checked in step 504, in particular the identifier of a peer the rating information of which is requested. This identifier is compared 506 to the identifiers in the user profile association storage. If specific primary keys for searching are applied, the identifier is compared to primary keys in the user profile association storage. Rating information in a user account including an identifier matching the identifier in the request is retrieved 508 from the user profile association storage. In step 510 a response message comprising the rating information is transmitted to the downloading peer 10.

Referring to FIG. 5b, in step 552 a message for updating rating information is received. This message may be received from a peer device 10 that has uploaded data, or from a peer device 10 that has downloaded data. An identifier of a peer device 10, whose rating information is to be updated, is checked in step 554 from the request, or otherwise defined on the basis of the request. The identifier is compared to identifiers in the user profile association storage in step 556. If there is a match, in step 558 it is checked if the updating message is reporting a downloading or an uploading activity for the peer device 10 identified in the request. In the case of an uploading, rating information in a user account including the matching identifier is updated to indicate an upgraded rating 560. If the request is for updating rating information of a downloading peer, step 562 is entered and rating information is updated to indicate downgraded rating in the user account including the matching identifier.

In one embodiment the messages transmitted in step 410 and 460 comprise an indicator of whether the update message is for a downloading peer device or for an uploading peer device. In another embodiment specific upload rating update and download rating update message types are applied in the communication between the peer devices 10 and the P2P proxy 50.

In one embodiment differing from FIG. 4a, the uploading peer device also triggers the updating of its own rating. In this embodiment the uploading peer may send a message, such as the one illustrated above in connection with step 460. Alternatively, a specific message indicating both the activities of the uploading peer and the downloading peer could be sent in step 410. Hence, no activities are required from the downloading peer for arranging updating of the user profile association storage. In another embodiment, the downloading peer device triggers the updating of its own rating on the basis of the downloading activity.

In one embodiment the user profile association storage comprises registration information, and the peer devices 10 are configured to perform a registration procedure with the P2P proxy 50. This registration procedure may be carried out before creating an entry to the user profile association storage and/or accessing the user profile association storage. In one embodiment the user profile association storage and the peer devices 10 comprise authentication information and the peer devices 10 are configured to perform an authentication procedure with the P2P proxy 50. In another embodiment an AAA (authentication, authorization, and accounting) server is contacted. The AAA server comprises user authentication information and is arranged to perform the authentication procedure for the user. The P2P proxy 50 may be arranged to further continue to use the user profile association storage for the user in response to a message from the AAA server indicating successful authentication. For instance, authentication may be required for registering the user and for establishing an entry for the user in the user profile association storage. It is to be noted that the registration procedure may be optional, and the user profile association storage may be arranged dynamically without specific registration and authentication procedure. In this case a validity period may be set for the entries in the storage.

The communication between the peer devices 10 and the P2P proxy 50 may be arranged on the basis of the applied P2P protocol and the underlying infrastructure. For instance, the HTTP or the HTTPS protocol may be used to deliver the above illustrated messages.

In many network configurations IP addresses are dynamically allocated. For this reason the user profile association storage may comprise other types of identifiers, for instance network specific identifiers. In one embodiment mobile network identifiers, such as the IMEI, IMSI or ESN already mentioned, are applied for identifying a P2P device. Some further embodiments are illustrated in the following. In one embodiment mobile network specific identifiers of one or more users (or subscribers) are stored in the user profile association storage. In a further embodiment the P2P peer software in a mobile terminal device may be arranged to define an appropriate mobile network specific identifier allocated for the device. For instance, the P2P peer 10 may be arranged to request the identifier from an entity controlling underlying mobile communications services in the device. Alternatively, the P2P peer 10 may be configured to check a predetermined memory location storing the identifier. The P2P peer 10 may then send the mobile network specific identifier to the P2P proxy 50 when requesting updating of its own rating. If the embodiment illustrated in FIGS. 4a and 4b is used, the P2P peers 10 may determine their own mobile network specific identifier and then send it to the other P2P peer. For instance, in step 456 the downloading peer specifies its IMSI, IMEI, or ESN in a P2P data request message. In an alternative embodiment the P2P peer 10 may be arranged to determine the mobile network specific identifier of the other P2P peer, for instance in step 404. This identifier may be defined on the basis of a request to a home location register (HLR) or another element comprising identifier-mapping information. An IP address or another identifier received from the P2P peer 10 may be submitted to the HLR, which is arranged to respond by submitting the mobile network specific identifier.

In another embodiment applying mobile network specific identifiers, the P2P proxy 50 contacts a mobile network element, such as the HLR comprising identifier-mapping information, and submits the received mobile network specific identifier. The HLR is arranged to determine another identifier currently or permanently associated with the received mobile specific identifier, for instance an IP address currently allocated to the peer device 10 and associated with the IMSI in the HLR. The associated identifier is sent to the P2P proxy 50, which may then compare the received identifier to the identifiers in the user profile association storage and update the rating of an entry including the identifier or retrieve the rating of such an entry. In a further embodiment, the mobile network element such as the HLR, is arranged to contact an AAA server before replying to the P2P proxy 50. The AAA server may use the mobile network specific identifier for authentication. After a response from the AAA server, the HLR may be arranged to transmit the response and the associated identifier to the requesting P2P proxy 50.

Hence, for implementing the above embodiments, at least some P2P messages between the P2P peers 10 and/or between the P2P peer 10 and the P2P proxy 50, in one embodiment implemented by HTTP GET requests, comprise a field for a mobile network specific identifier associated with the P2P message. The field may comprise an identifier of the sender of the message and/or another P2P peer 10 (the rating of which is requested, for instance).

In another embodiment, the P2P proxy 50 is configured to initiate the determining of the mobile network specific identifier associated with a P2P peer 10 in step 504 or 554. After receiving a message (requesting rating information or updating of rating information) from a P2P peer 10, the P2P proxy 50 may contact an HLR and/or another register, such as the equipment identity register EIR comprising user information, in the mobile network 20 for checking the mobile network specific identifier associated with the P2P peer. In this embodiment an identifier of the P2P peer 10 may be obtained from the received P2P message. For instance, an IP address, a user identifier or another identifier applied in P2P communication may be used. The HLR stores the user information, and the associated mobile network specific identifier may be obtained on the basis of the identifier received from the P2P peer 10. The identifier is sent to the P2P proxy 50 which may then operate, as already illustrated in connection with FIGS. 5a and 5b, by comparing first the received identifier to the identifiers in the user profile association storage.

In one embodiment the P2P proxy 50 is configured to check a predetermined identifier in step 604 and 554. As already mentioned, the P2P proxy 50 may be configured to check a specific P2P message field comprising the identifier, or check some other filed, for instance an IP header. This identifier is the primary identifier type for the user profile association storage. Correspondingly, the P2P peers 10 are configured to define this identifier to the messages in step 406 and 460. However, the P2P proxy 50 may be configured to check also other identifiers in step 404 and 454. In one embodiment the P2P proxy 50 is configured to check one or more secondary identifiers if the primary identifier cannot be defined on the basis of the received message. Depending on the applied implementation, the secondary identifier could be checked from the P2P message content or from other information associated with the received message. For instance, if no user identifier is found in the message, the P2P proxy 50 may be configured to check a field for IP address as a secondary identifier, and possibly initiate checking of a third identifier on the basis of the secondary identifier. This embodiment may be used to arrange the usage of the user profile association storage with different P2P protocols having different message contents. For instance, the P2P proxy 50 may be configured to perform multiple P2P protocol specific checks successively.

In the following an embodiment for applying the user profile association information storage in a P2P system supporting the BitTorrent technology is discussed. BitTorrent is designed for groups of users with an interest in downloading a file or a set of files and cooperating to speed-up the process. An original file distributor may create a tracker allowing peers Interested in the file to find each other. To download the file, a peer contacts the tracker. The tracker does not host any actual contents, but only meta-data associated with it. There are two kinds of interaction between peers and the tracker: A peer asks the tracker about other peers, and peers keep the tracker updated with their own status regarding the download of the file. When asked for peers, a tracker will return a list of other peers currently connected to the tracker. It uses the status information provided by the peers to maintain an up-to-date list.

Once a peer or a client (in the BitTorrent specification also the term “client” is used to refer to a peer, however it is the BitTorrent client that is running on the local machine) has obtained a list of other peers, it will contact them to try to retrieve the data it is looking for. With BitTorrent, files are broken into smaller fragments, typically a quarter of a megabyte each. As the fragments are distributed to the peers in a random order, they can be reassembled on a requesting machine. Each peer takes advantage of the best connections to the missing pieces while providing an upload connection to the pieces it already has. As a peer downloads fragments, it also uploads previously downloaded fragments to other peers. Peers in BitTorrent cooperate: a peer is more likely to upload to those peers that have recently downloaded to it. Not all peers connected to a client are served: all peers which are not being served are said to be choked. Each client implements an algorithm to choose which peers to choke and un-choke among those connected to him over time. The approach in BitTorrent is named “tit-for-tat”, meaning that a client will preferably cooperate with the peers cooperating with him. This means that each client measures how fast it can download from each peer and, in return, it will serve those from whom it has the better download rates. When a client has finished downloading a file it no longer has a download rate from other peers but it can still share (upload) pieces of the file. In this case the choking algorithm is applied by considering the upload rate. Peers are selected based on how fast they can be uploaded to.

The BitTorrent protocol specification v. 1.0 can be obtained at www.bittorrent.com.lt describes the message contents applied in the BitTorrent protocol. In one embodiment a device functioning as the tracker is arranged to perform at least some of the features illustrated above for the P2P proxy 50. The prioritization information in the user profile association storage is updated in accordance with the BitTorrent prioritization system, and the BitTorrent uploading process is arranged on the basis of the prioritization information associated with an identifier of the downloading device's identifier.

The application of the above illustrated embodiments is not limited to any specific P2P technology. If implemented in devices supporting the eMule P2P technology, the eMule peers are arranged to understand and use the user profile association information storage.

In the above embodiments the P2P proxy 50 maintains the user profile association information on the basis of messages from the P2P peers 10. However, instead of a proxy device, a specific server device or a server type of software may be arranged In the P2P system to maintain the user profile association storage. At least some of the above illustrated features may be provided by such a server, which could also be referred to as a rating server. Such a dedicated rating server provides the P2P peers 10 with services related to the user profile association storage table, in particular to identify different devices belonging to the same user or to a group. The rating server may be connected to other network elements, for instance to the HLR for requesting identifier mapping.

In one embodiment, herein referred to as the distributed approach, there is no centralized P2P proxy 50, but the user profile association information is stored in a distributed fashion in the P2P system. At least some P2P peer devices 10 may be arranged to maintain the user profile association storage in a coordinated fashion. Hence, at least some of the above illustrated features may be carried out between P2P peer devices 10 and/or internally in a peer device 10. For instance, instead of the above request and response messages, an uploading P2P peer 10 receiving a request for data uploading may check the downloading peer's rating information from a user profile association storage in the memory storage area 202. If the downloading peer's entry is not found, the uploading peer may transmit a request for the downloading peer's information to one or more other devices. The P2P peers 10 may thus co-operate to maintain the user profile association storage. “Serving” peer devices receive messages for rating information request and/or update. Further, such serving P2P peer 10 is arranged to retrieve and/or update rating information in the storage on the basis an identifier from a received request. The identification of the peer can be done by the originating (uploading) peer that requests the rating information or by the neighbor peers that answer a request. Broadcast or multicast message transfer may be applied for transferring the messages between the P2P peers. In one embodiment the ID tables are updated through propagation from one peer to another.

In one embodiment each peer device 10 maintains information of at least some other peer devices in the current P2P network and forwards rating updates or indications of occurred transactions to other peer devices. The rating information is propagated from one peer to another without a central storage. When an uploading peer needs to know the rating information of another peer it may ask this from it's neighbor peers. Based on their response, the uploading peer can get a good understanding of the rating. The neighbor peers may not exactly know the latest rating information, but since rating information is received from multiple peers the overall rating information is accurate enough.

The user profile association storages may be used by P2P peers 10 in a local network. In P2P systems “local” user groups may be formed for data sharing, i.e. virtual P2P networks are dynamically formed. In one embodiment the user profile association information storage is local, user information is stored in the user profile association information storage only for users belonging to the user group, or for peers 10 located in a specific area. For instance, in the above embodiments the uploading peer may transmit requests for rating information to neighboring P2P peers, and rating information is updated on the basis of the transactions of local P2P peers. It is to be noted that the local user groups or storages do not have to be bound to one or more physical networks, but may form virtual P2P subnetworks regardless of the physical location of the peers 10.

When local user profile association information storages are applied, users are assigned by local priority, which is used to define their data transmission in the context concerned, such as in a specific network. The user profile association information storages may also be arranged such that a global rating is maintained for a user. Thus, substantially all P2P data transfer regarding any of the user's devices are reported to the user profile association information storage (which may be formed of multiple storages). In one embodiment the distributed model provides a mix of local and global rating using information a group or all neighbors (or even including neighbors' neighbors). The local rating system is easier to implement but the global rating system provides better protocol scalability in the sense that it reflects a more long-term tit-for-tat algorithm.

In BitTorrent or eMule peers are enhanced to maintain the user profile association information storage. In trackerless mode of the BitTorrent the functions of the BitTorrent tracker are distributed among the peers. This tracker functionality in the peer may also be arranged to provide above illustrated features related to the user profile association information storage.

In one embodiment some of the P2P peers 10 of the P2P system are equipped with additional capability to provide at least some of the functions illustrated above for the P2P proxy 50. Such specialized P2P peers could be referred to as “super peers”. These specialized P2P peers may be dynamically chosen and they help other peers. The specialized P2P peer could help with the ID translation to identify the user accessing the P2P network by different devices/networks. The specialized P2P peer may maintain the user profile association storage on the basis of messages from other P2P peers reporting transactions and submit rating information to requesting peers. These specialized P2P, besides serving other peers, may in one embodiment also function as P2P peers requesting the rating information and adapting the data transmission on the basis of the rating information. In another embodiment the specialized peer is arranged to participate in the user profile association information maintenance and delivery, for instance by mediating P2P peers' requests and responses. The specialized peer may be configured to contact another entity, such as the HLR.

In another embodiment a peer device launching a specific file for the first time is arranged to maintain the user profile association storage. The other peer devices then register with the first peer device and with the user profile association storage. After registration, their data transfer actions would be reported to the first peer device and the rating information would be modified accordingly. For instance, referring to the BitTorrent, the tracker could be configured to provide the steps illustrated above in connection with FIGS. 5a and 5b.

The accompanying drawings and the description pertaining to them are only intended to illustrate the present invention. Different variations and modifications to the invention will be apparent to those skilled In the art, without departing from the scope of the invention defined in the appended claims. Different features may thus be omitted, modified or replaced by equivalent one.

1-24. (canceled)

25. A method for arranging service provision in a peer-to-peer communication system, the method comprising:
detecting a user instance identifier associated with a peer-to-peer data transfer action;
checking prioritization information from a user profile association information storage associated with the user instance identifier, the user profile association information storage being arranged for associating at least two user instance identifiers with the prioritization information; and
adapting the data transfer action based on the prioritization information.

26. The method of claim 25, wherein the user profile association information storage is arranged for associating at least two user instance identifiers from different devices with a single prioritization information item.

27. The method of claim 25, wherein the user profile association information storage is arranged for associating at least two user instance identifiers with the prioritization information using at least one entry, the at least one entry comprising the prioritization information and at least one identifier type selected from the group consisting of a P2P application specific identifier, an IP address, a domain name, a port number, a user identifier, a user group identifier, a mobile subscriber identifier, and a mobile device identifier.

28. The method of claim 25, wherein the user profile association information storage is located in a first electronic device and at least one of the at least two user instance identifiers is associated with or identifies a second electronic device.

29. The method of claim 1, further comprising updating the prioritization information based on the data transfer action.

30. A communications device configured to access a peer-to-peer communication system, the communication device comprising:
a processor; and
a memory unit operatively connected to the processor and including:
computer code for detecting a user instance identifier associated with a peer-to-peer data transfer action;
computer code for checking prioritization information from a user profile association information storage associated with the user instance identifier, the user profile association information storage being arranged for associating at least two user instance identifiers with the prioritization information; and
computer code for adapting the data transfer action based on the prioritization information.

31. The device of claim 30, wherein the device is configured to communicate with a second device including or having access to the user profile association information storage, the device further being configured to transmit the user instance identifier associated with the data transfer action to the second device for initiating an update of prioritization information in an entry comprising an identifier matching with the user instance identifier associated with the data transfer action.

32. The device of claim 30, wherein the device is configured to communicate with a second device including or having access to the user profile association information storage, the device further being configured to:
transmit to the second device a request for prioritization information associated with the user instance identifier;
receive the requested prioritization information from the second device; and
adapt data transmission based on the received prioritization information.

33. The device of claim 30, wherein the device includes or has access to the user profile association information storage and wherein the device is configured to:
compare the user instance identifier associated with the data transfer action to identifiers in the user profile association information storage; and
check prioritization information in an entry comprising an identifier which matches the user instance identifier; or
update the prioritization information in an entry comprising an identifier which matches the user instance identifier based on the data transfer action.

34. The device of claim 33, wherein the prioritization information comprises a rating indicator and wherein the device is configured to:
update the rating indicator to indicate an upgraded rating for entities associated with the user instance identifier in response to detecting an upload from a device associated with the user instance identifier in the user profile association information storage; and
update the rating indicator to indicate a downgraded rating for entities associated with the user instance identifier in response to detecting a download to a device associated with the user instance identifier in the user profile association information storage.

35. The device of claim 30, wherein the user profile association information storage is arranged for associating at least two user instance identifiers with the prioritization information using at least one entry, the at least one entry comprising the prioritization information and at least one identifier type selected from the group consisting of a P2P application specific identifier, an IP address, a domain name, a port number, a user identifier, a user group identifier, a mobile subscriber identifier, and a mobile device identifier.

36. The device of claim 30, wherein the device is configured to adapt a peer-to-peer uploading process based on the prioritization information.

37. A communications device configured to access a peer-to-peer communication system and a user profile association information storage, the user profile association information storage being arranged for associating at least two user instance identifiers with prioritization information, the communication device comprising:
a processor; and
a memory unit operatively connected to the processor and including:
computer code for receiving a message from a peer device, the message comprising a user instance identifier associated with a data transfer action;
computer code for comparing the received user instance identifier to identifiers in the user profile association information storage, and
computer code for updating the prioritization information associated with the received user instance identifier based on the data transfer action; or
computer code for transmitting the prioritization information to the peer device.

38. The device of claim 37, wherein the user profile association information storage is arranged for associating at least two user instance identifiers with the prioritization information using at least one entry, the at least one entry comprising the prioritization information and at least one identifier type selected from the group consisting of a P2P application specific identifier, an IP address, a domain name, a port number, a user identifier, a user group identifier, a mobile subscriber identifier, and a mobile device identifier.

39. The device of claim 37 wherein the prioritization information comprises a rating indicator and wherein the device is configured to:
update the rating indicator to indicate an upgraded rating for entities associated with the user instance identifier in response to detecting an upload from a device associated with the user instance identifier in the user profile association information storage; and
update the rating indicator to indicate a downgraded rating for entities associated with the user instance identifier in response to detecting a download to a device having an identifier associated with a user in the user profile association information storage.

40. A peer-to-peer communication system, the system comprising:
at least two peer-to-peer communication entities, wherein the system is configured to:
detect a user instance identifier associated with a peer-to-peer data transfer action,
check prioritization information from a user profile association information storage associated with the user instance identifier, the user profile associating information storage being arranged for associating at least two user instance identifiers with the prioritization information; and
adapt the data transfer action based on the prioritization information.

41. A computer program product comprising computer code embodied on a computer readable medium in a communication device, the computer code configured for:
detecting a user instance identifier associated with a peer-to-peer data transfer action,
checking prioritization information from a user profile association information storage associated with the user instance identifier, the user profile associating information storage being arranged for associating at least two user instance identifiers with the prioritization information; and
adapt the data transfer action based on the prioritization information.

42. The computer code product of claim 41, further comprising:
computer code for configuring the device to transmit the user instance identifier associated with the data transfer action to the second device for initiating an update of prioritization information in an entry comprising an identifier matching with the user instance identifier associated with the data transfer action.

43. The computer code product of claim 41, further comprising:
computer code for configuring the device to transmit a request for prioritization information associated with the user instance identifier associated with the data transfer action to a second device; and
computer code for adapting data transmission based on the requested prioritization information.

44. The computer code product of claim 41, further comprising:
computer code for configuring the device to compare the user instance identifier associated with the data transfer action to identifiers in the user profile association information storage; and
computer code for checking the prioritization information in an entry comprising a matching identifier; or
computer code for updating an entry comprising a matching identifier based on the data transfer action.

45. The computer code product of claim 41, further comprising:
computer code for configuring the device to compare the user instance identifier associated with the data transfer action to identifiers in the user profile association information storage; and
computer code for updating the prioritization information in an entry comprising a matching identifier based on the data transfer action; or
computer code for transmitting the prioritization information in an entry comprising a matching identifier to a peer device.

46. The computer code product of claim 41, further comprising computer code for configuring the device to adapt a peer-to-peer upload process based on the prioritization information.
